(19) United States
(12) Patent Application Publication
(10) Pub. No.: US 2016/0343049 A1
(43) Pub. Date: Nov. 24, 2016

(54) SMART PUBLICATION LISTINGS ENGINE

(71) Applicant: eBay Inc., San Jose, CA (US)

(72) Inventor: Rahul Nair, Austin, TX (US)

(21) Appl. No.: 14/715,981

(22) Filed: May 19, 2015

(51) Int. Cl. G06Q 30/06

(52) U.S. Cl. CPC G06Q 30/0601

(57) ABSTRACT

A central listings engine comprises at least one processor programmed to receive a central listing associated with a target offering, the central listing including a plurality of data elements, the target offering including one of a product and a service a seller is presenting for sale through e-commerce, the plurality of data elements including a first subset of data elements including identification of a first online marketplace and a second subset of data elements including identification of a second online marketplace. The central listings engine also generates first and second listing creation requests associated with the target offering, and further transmits the first listing creation request to first marketplace to create a first local listing for the target offering on the first online marketplace, and transmits the second listing creation request to second marketplace to create a second local listing for the target offering on the second online marketplace.

### TECHNICAL FIELD

Embodiments of the present disclosure relate generally to online publication systems and networks for publishing listings and, more particularly, but not by way of limitation, to a smart listings engine and related systems and methods.

### BACKGROUND

An online publisher in a publication network, such as a seller, may list an item for sale on multiple marketplace websites such as, for example, ebay.com, amazon.com, and walmart.com. For example, an online seller who sells in multiple geographic markets may enter a listing for an item on ebay.com and separately enter a listing for the same item on amazon.com. Having to create multiple listings on multiple marketplaces (e.g., in order to offer the sale to potentially different pools of potential customers) costs the online seller extra resources (e.g., human resources, time, expense) to create and maintain the listings on the multiple marketplace websites. Further, segmentation of the multiple associated listings across disconnected marketplace websites may cause multiple sales for a single item.

### BRIEF DESCRIPTION OF THE DRAWINGS

Various ones of the appended drawings merely illustrate example embodiments of the present disclosure and cannot be considered as limiting its scope.

FIG. 1 illustrates a network diagram depicting an example listings system in which a central listings engine generates and/or managing listings with a plurality of online publication systems, or “marketplaces”, according to some embodiments.

FIG. 2 illustrates a block diagram showing components provided within the central listings engine shown in FIG. 1 according to some embodiments.

FIG. 3 is a diagram of an example graphical user interface (“GUI”) or “seller GUI” for inputting a global listing via the central listings engine shown in FIGS. 1 and 2.

FIG. 4 is a diagram illustrating communications between the central listings engine shown in FIG. 1 and a plurality of marketplaces during the processing of a central listing.

FIG. 5 is a diagram of an example method for creation and management of listings across multiple marketplaces, such as the marketplaces shown in FIGS. 1 and 4.

FIG. 6 is a flow chart of an example method for providing a seller interface for creating a central listing on a central listings engine.

FIG. 7 is a block diagram illustrating a representative software architecture, which may be used in conjunction with various hardware architectures herein described.

FIG. 8 is a block diagram illustrating components of the machine shown in FIG. 7, according to some example embodiments, able to read instructions from a machine-readable medium (e.g., a machine-readable storage medium) and perform any one or more of the methodologies discussed herein.

The headings provided herein are merely for convenience and do not necessarily affect the scope or meaning of the terms used. Like numbers in the Figures indicate like components.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Some known online publication systems, for example e-commerce systems (also referred to herein as “online marketplaces” or “marketplace websites”) enable at least some of their users (also sometimes referred to herein as “sellers”) to offer products for sale to other users (referred to herein as “buyers” or “customers”) over the Internet (e.g., “consumer-to-consumer” and/or “business-to-consumer” sales, auctions). Current examples of such marketplace websites include, for example, Ebay.com™ (eBay, Inc., a Delaware Corporation), Amazon.com® (Amazon.com, Inc., a Delaware Corporation), and Walmart.com® (Wal-mart Stores, Inc. a Delaware Corporation) (e.g., “marketplace retailers”).

A central listings engine and associated systems and methods are described herein. The central listings engine may alleviate some of the problems discussed herein for at least some sellers, as well as yielding technical benefits to the functioning of the computer systems involved.

The central listings engine facilitates creation and management of listings across multiple marketplaces such that the user (e.g., a seller of products or services on the Internet, or just “seller”) need only enter a listing once (i.e., via entry of a “central listing” on the centralized listings engine). The central listings engine then propagates the central listing across one or more marketplaces (sometimes referred to herein as “adjunct marketplaces”). In some embodiments, this central listing is turned into one or more “local listing”, or listing entered onto one or more adjunct marketplaces. Examples of adjunct marketplaces include, for example, ebay.com and amazon.com. It should be noted that fictitious website names such as firstmarketplace.com and secondmarketplace.com are sometimes used herein to refer, generically, to distinct marketplaces, for purposes of discussion.

In the example embodiment, the central listings engine provides a graphical user interface (“GUI”, or “central listing entry interface”) to a seller. The GUI enables the seller to enter a central listing for a “target offering”, a product or service that the seller wishes to list across one or more of the adjunct marketplaces. For purposes of convenience, the examples described herein will discuss a target offering as a product, or “target product”, being offered for sale by the seller through the central listings engine.

Through the GUI, the seller enters two types of data about the target product: “shared data listing elements” and “local data listing elements” (sometimes collectively referred to jointly as “data listing elements”). The shared data listing elements are data items that may be commonly used for each local listing (e.g., data that is not dependent on or specific to a particular adjunct marketplace). This data may include, for example, item information such as item condition, item name, and item description. The local data listing elements are data items that are specific to just one local listing (i.e., for a listing being created on just one of the adjunct marketplaces). This data may include, for example, a local market identifier (e.g., identifying a geographic region within which the local listing will appear on the adjunct marketplace), a shipping carrier, a price amount, a tax amount, and a total price amount.

The GUI enables the user to enter the shared data listing elements for the target product (e.g., to be commonly used across one or more of the local listings). For example, the seller may be selling an autographed Wayne Gretzky hockey trading card, and the seller may enter the item's condition and an item description in associated fields.

The GUI also enables the user to select one or more adjunct marketplaces to which the target product will be offered for sale (i.e., to which local listings will be created). For each adjunct marketplace selected by the seller, the GUI presents one or more local data listing elements (e.g., fields) into which the seller may identify data that applies specifically to that local listing (i.e., to that adjunct marketplace). For example, the user may select firstmarketplace.com and secondmarketplace.com as two adjunct marketplaces for which to create local listings. As such, the GUI presents two columns of data fields (e.g., for local data listing elements), one column for the firstmarketplace.com listing, and another column for the secondmarketplace.com listing. Within each column, the seller is able to select the values that she wishes to use for for that target product, and particular to the local listing for that adjunct marketplace. For example, the seller may elect to generate a listing for the Wayne Gretzky trading card on firstmarketplace.com and secondmarketplace.com, and they may select a market of “Canada” for the firstmarketplace.com listing, and “USA” for the secondmarketplace.com listing. Further, the seller may perceive that Canadians may be willing to pay slightly more for this type of product, so they may enter a higher purchase price for the firstmarketplace.com listing (e.g., “$200.00”) as compared to the secondmarketplace.com listing (e.g., “$185”) (e.g., in the hope to sell for a little higher price than they could likely get in other venues).

In some embodiments, the GUI presents a palette of options for particular fields, and the seller is able to drag and drop a selection from the palette onto the desired column, or onto a particular shared data listing element, thereby specifying the value to use for that particular data listing element (e.g., for a particular local listing, or for all of the listings).

Once the seller has entered the listing information, the seller submits the central listing through the GUI. The central listings engine then creates and stores the central listing in a central listings database. Further, the central listings engine also creates a local listing on each of the identified adjunct marketplaces. Continuing the above example, the central listings engine generates a local listing on secondmarketplace.com, and that local listing specifies the shared data listing elements of the item condition, item name, and item description as entered by the seller, as well as the specific market (“USA”) and price (“$185”) as specified by the seller in the secondmarketplace.com column of the GUI. The central listings engine also generates a local listing on firstmarketplace.com, and that local listing specifies the same shared data listing elements, as well as the specific market (“Canada”) and price (“$200”) as specified by the seller in the firstmarketplace.com column of the GUI. As such, the central listings engine enables the seller to generate multiple listings across multiple marketplaces from the entry of a single, central listing.

In some embodiments, the central listings engine performs additional tasks associated with managing listings across the adjunct marketplaces. For example, in one embodiment, the central listings engine identifies when an item has sold on one adjunct marketplace and performs additional operations such as cancelling the other listings on other adjunct marketplaces (e.g., if the listing was for a single item, such as the autographed trading card). For another example, the central listings engine may decrement an available quantity across other listings (e.g., if the listing included an inventory quantity or pool of items from which multiple buyers may buy).

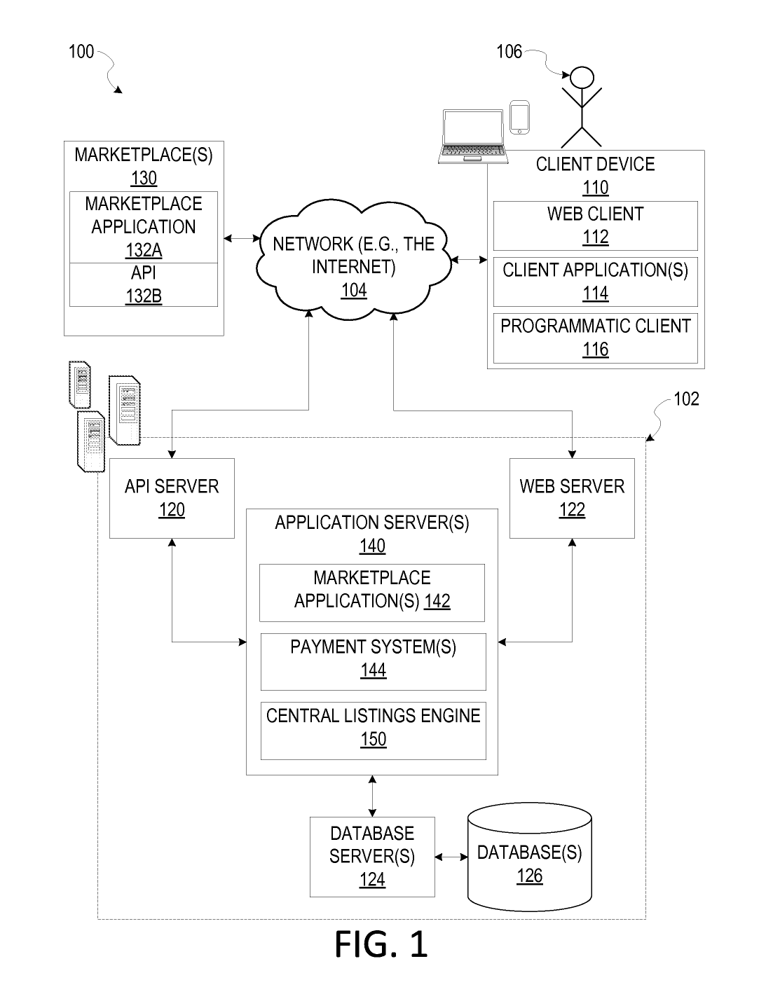

FIG. 1 illustrates a network diagram depicting an example listings system 100 in which a central listings engine 150 generates and/or managing listings with a plurality of online publication systems, or “marketplaces”, 130 according to some embodiments. The marketplaces 130 list products and/or services for sale (e.g., as “listings”) from, for example, online merchants, individual sellers, wholesalers, and other sellers of goods and services. These listings may be in a variety of forms such as, for example, immediate-sale type transactions, or auction type transactions. A networked system 102 forms a network-based, centralized publication system that provides server-side functionality, via a network 104 (e.g., the Internet or Wide Area Network (WAN)), to one or more client devices 110 that may be used, for example, by sellers 106 and/or buyers (not separately shown) of products and services offered for sale through marketplaces 130. FIG. 1 further illustrates, for example, one or both of a web client 112 (e.g., a web browser), client application(s) 114, and a programmatic client 116 executing on client device 110.

Each of the client machines 110 comprises a computing device that includes at least a display and communication capabilities with the network 104 to access the networked system 102. The client device 110 includes devices such as, but not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. Each of the client devices 110 may connect with the network 104 via a wired or wireless connection. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client devices 110 includes one or more applications (also referred to as “apps”) 114 such as, but not limited to, a web browser, messaging application, electronic mail (email) application, a publication site application (also referred to as a marketplace application), and the like. In some embodiments, if the publication site application 114 is included in a given one of the client devices 110, then this application is configured to locally provide the user interface and at least some of the functionalities with the application configured to communicate with the networked system 102, on an as needed basis, for data and/or processing capabilities not locally available (such as access to a database of items available for sale, to authenticate a user, to verify a method of payment, etc.). Conversely, if the publication site application 114 is not included in a given one of the client devices 110, the given one of the client devices 110 may use its web client 112 to access the publication site (or a variant thereof) hosted on the networked system 102. Although only one client device 110 is shown in FIG. 1, two or more client devices 110 may be included in the publication system 100.

An Application Program Interface (API) server 120 and a web server 122 are coupled to, and provide programmatic and web interfaces respectively to, one or more application servers 140. In the example embodiment, the application servers 140 host a central listings engine 150 that facilitates creating and/or managing listings on the marketplaces 130, as described herein. The application servers 140 are, in turn, shown to be coupled to one or more database servers 124 that facilitate access to one or more databases 126.

In some embodiments, the application servers host one or more marketplace applications 142 and payment applications 144. The marketplace applications 142, like marketplace applications 132A, may provide a number of publication functions and services to users that access networked system 102 and/or marketplaces 130. Publication functions/services may include a number of publisher functions and services (e.g., search, listing, content viewing, payment, etc.). For example, the marketplace applications 142 may provide a number of services and functions to users for listing goods and/or services or offers for goods and/or services for sale, searching for goods and services, facilitating transactions, and reviewing and providing feedback about transactions and associated users. Additionally, the marketplace applications 142 may track and store data and metadata relating to listings, transactions, and user interactions. In some embodiments, the marketplace applications 142 may publish or otherwise provide access to content items stored in application servers 140 or databases 126 accessible to the application servers 140 and/or the database servers 124. The payment applications 144 may likewise provide a number of payment services and functions to users. The payment applications 144 may allow users to accumulate value (e.g., in a commercial currency, such as the U.S. dollar, or a proprietary currency, such as “points”) in accounts, and then later to redeem the accumulated value for products or items (e.g., goods or services) that are made available via the marketplace applications 142. While the marketplace and payment applications 142 and 144 are shown in FIG. 1 to both form part of the networked system 102, it will be appreciated that, in alternative embodiments, the payment applications 144 may form part of a payment service that is separate and distinct from the networked system 102. In other embodiments, the payment applications 144 may be omitted from the system 100. In some embodiments, at least a portion of the marketplace applications 142 may be provided on the client devices 110.

Further, while the system 100 shown in FIG. 1 employs a client-server architecture, embodiments of the present disclosure are not limited to such an architecture, and may equally well find application in, for example, a distributed or peer-to-peer architecture system. The various marketplace and payment applications 142 and 144 may also be implemented as standalone software programs, which do not necessarily have networking capabilities.

The client devices 110 access the various marketplace and payment applications 142 and 144 via the web interface supported by the web server 122. Similarly, the programmatic client 116 accesses the various services and functions provided by the marketplace and payment applications 142 and 144 via the programmatic interface provided by the API server 120. The programmatic client 116 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 116 and the networked system 102.

In the example embodiment, the central listings engine 150 enables sellers to input and create a “central listing” for products and services offered for sale. In some embodiments, central listings and associated information may be stored in databases 126 for ongoing tracking operations. The central listings engine 150 communicates with marketplaces 130 and, more particularly, marketplace applications 132A. In some embodiments, the central listings engine 150 and marketplaces 130 communicate together through API server 120 of system 102 and/or API 132B of marketplaces 130. During operation, the central listings engine 150 transmits listings creation operations to one or more marketplaces 130 when a seller (e.g., user 106) submits a central listing. More specifically, in the central listing, the seller 106 specifies on which marketplaces 130, 142 the seller wishes to offer their product for sale (e.g., create a listing), along with additional sales details (described in greater detail below). The central listings engine 150 then generates and transmits a listings creation operation to each of the marketplaces 130, 142 specified by the seller 106. As such, the central listings engine 150 causes local listings to be created on one or more marketplaces 130, 142.

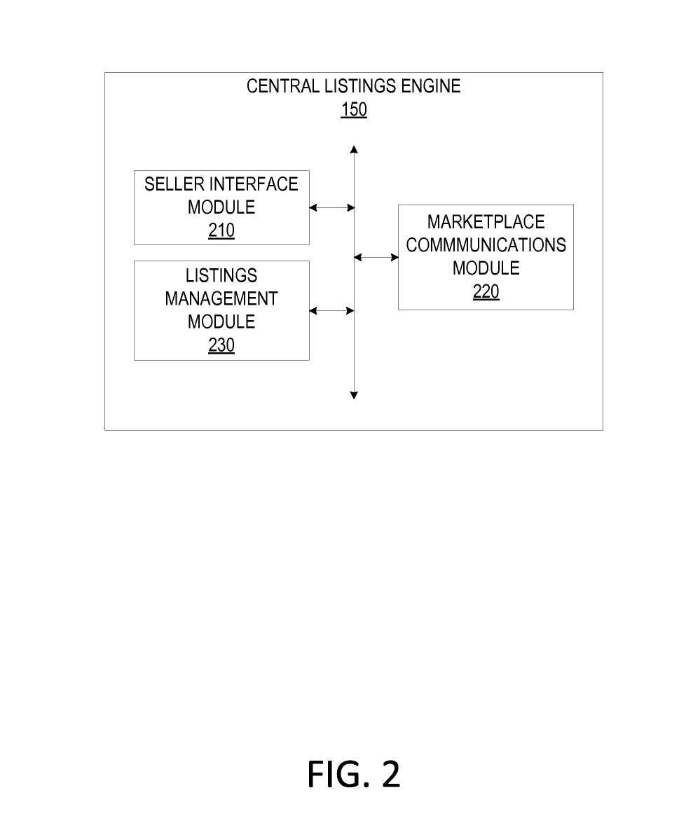

FIG. 2 illustrates a block diagram showing components provided within the central listings engine 150 according to some embodiments. The central listings engine 150 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the database servers 124 (both shown in FIG. 1).

The central listings engine 150 may provide a number of publishing, listing, and/or price-setting mechanisms whereby a seller (e.g., seller 106 shown in FIG. 1) may list or otherwise publish information concerning goods or services for sale or barter to a plurality of marketplaces 130, 142 (shown in FIG. 1), a buyer can express interest in or indicate a desire to purchase or barter such goods or services (e.g., through the marketplaces 130, 142), and a transaction (such as a trade) may be completed pertaining to the goods or services.

To this end, the example central listings engine 150 includes a seller interface module 210, a marketplace communications module 220, and a listings management module 230. The seller interface module 210, in the example embodiment, provides a graphical user interface through which a seller (e.g., user 106, shown in FIG. 1) may enter a “central listing” for a product or service the seller wishes to offer for sale on one or more marketplaces 130, 142.

The term “central listing”, as used herein, refers to a set of offering data associated with a product or service offered for sale by a seller as input into the central listings engine 150. In other words, the central listing refers to the listing and data as entered by the seller prior to generating a listing on any of the marketplaces 130, 142. The central listing may include offering data for a plurality of marketplaces. The term “local listing”, as used herein, refers to a listing as created on a single marketplace 130 (i.e., the “local” marketplace of the listing). The local listing includes a set of offering data associated with the product or service as published on the local marketplace. As described herein, upon submission of a “central listing” through the central listings engine 150 (e.g., through the seller interface module 210), the central listings engine 150 generates and transmits listing creation operations to one or more marketplaces 130, causing local listings to be created on each of those marketplaces 130.

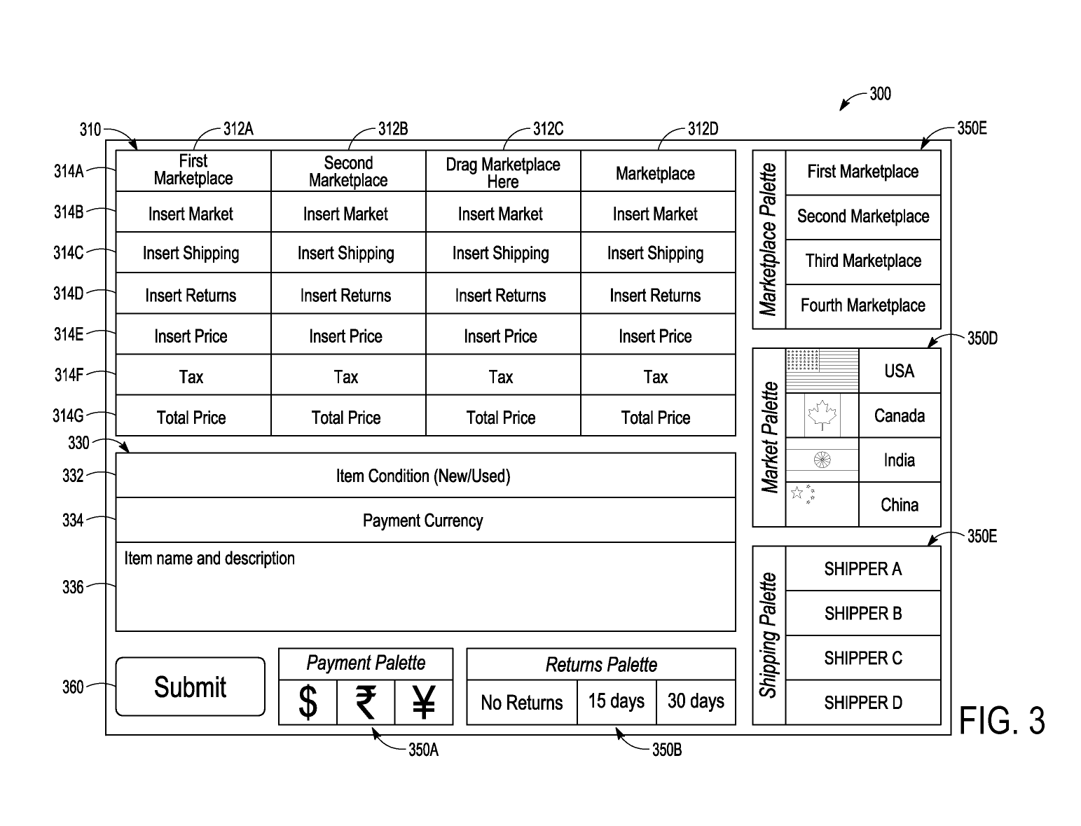

The seller interface module 210, in the example embodiment, presents a graphical user interface (“GUI”, or “seller GUI”) to the seller for creation of a central listing. The seller GUI provides data input capabilities enabling the seller to enter offering information for the product/service the seller wishes to sell. The seller GUI and associated offering information is described in greater detail below, with respect to FIG. 3.

In other embodiments, the seller interface module 210 receives offering information for a central listing through an API (e.g., through API server 120, shown in FIG. 1). As such, sellers may submit the offering information for a central listing through a programmatic interface.

Further, in some embodiments, the central listings engine 150 may receive listings information from a marketplace 130, from which the central listings engine 150 may generate “cross-listings,” or listings that are generated for the target product from one marketplace 130 to another marketplace. For example, the seller may initially list the target product on an individual marketplace 130 (referred to herein as an “original listing” on an “original listing marketplace”) and then pursue cross-listing the target product on “additional” or “secondary” marketplaces 130 through the central listings engine 150.

In some embodiments (e.g., “push cross-listing”), the original listing marketplace 130 collects listing information for the target product, such as shown and described herein, to use for creating listings on one or more additional marketplaces. The original listing marketplace 130 may provide a seller interface to the seller for collecting cross-listing information for the target product, for example as described herein, or by any system or method that enables cross-listing as described herein. In some embodiments, at least some of the cross-listing information may be populated from the listing information for the original listing. For example, an original listing price of the original listing for the target product may be pre-populated, defaulted, or selected for use in the cross-listings. This cross-listing information is then transmitted from the original listing marketplace 130 to the central listings engine 150. Upon receipt, in some embodiments, the central listings engine 150 may automatically generate a central listing for the target product, associate the central listing with the original listing, and/or automatically generate cross-listings on additional marketplaces 130 using the systems and methods described herein. In some embodiments, the central listings engine 150 may enable the seller to view, change, delete, or otherwise alter the cross-listing information prior to generating the cross-listings on the additional marketplaces 130.

In some embodiments (e.g., “pull cross-listing”), the seller cross-lists the original listing through the central listings engine 150. For example, the seller identifies the original listing and the original listing marketplace 130 for the target product via the seller interface module 210. The marketplace communications module 220 queries the original listing marketplace 130 for original listing information associated with the identified listing. The central listings engine 150 then enables the seller to identify additional marketplaces 130 for cross-listing the target product. In some embodiments, the central listings engine 150 generates a central listing and the cross-listings for the additional marketplaces 130 identified by the seller, wherein the original listing information is automatically used for the cross-listings. In other embodiments, the central listings engine 150 pre-populates the seller interface with at least some original listing information and enables the seller to complete, edit, change, add, or otherwise alter the cross-listing information prior to creating the cross-listings on the identified additional marketplaces 130.

In the example embodiment, the marketplace communications module 220 enables communications between the central listings engine 150 and the marketplaces 130, 142. Marketplace management module 220, for example, transmits listing creation requests to one or more marketplaces 130 after the user submits a central listing via the seller interface module 210. The transmission of the listing creation request to a particular marketplace 130 causes the marketplace 130 to establish or create a “local listing”, or a listing on that particular marketplace 130, for the product or service associated with the central listing. The marketplace communications module 220 may manage other types of communications with the marketplaces 130, 142 such as, for example, status query messages (e.g., for determining status of a local listing) and status update messages (e.g., messages indicating that a local listing has sold, or has expired, or has been cancelled, removed, or other change of status). In some embodiments, the marketplace communications module 220 may transmit and receive inventory update information (e.g., an update of item count remaining on all marketplaces) from marketplaces 130, 142. In some embodiments, the marketplace communications module 220 may publish and/or cross-publish FAQs and product reviews across the listing marketplaces.

The listings management module 230 performs various tasks associated with managing listings. In the example embodiment, the listings management module 230 generates one or more listing creation requests when a central listing is submitted. The listings management module 230 also stores, accesses, updates, or otherwise manages central listings (e.g., stored in databases 126).

FIG. 3 is a diagram of an example graphical user interface (“GUI”) or “seller GUI” 300 for inputting a global listing. In some embodiments, the seller GUI 300 is presented to a seller such as seller 106 (shown in FIG. 1) by the seller interface module 210 (shown in FIG. 2). The seller GUI 300 enables the seller to enter a central listing for a product or service that the seller wishes to list across one or more of the adjunct marketplaces. For purposes of convenience, the examples described herein will discuss a product, or “target product”, being offered for sale by the seller through the central listings engine.

In the example embodiment, the seller GUI includes a local data region 310, a shared data region 330, a plurality of palettes 350A, 350B, 350C, 350D, and 350E (collectively, palettes 350), and a submit button 360. The shared data region 330 includes data fields that are shared or common across multiple local listings. In the example embodiment, the shared data region 330 includes an item condition field 332 (e.g., new, used), a payment currency field 334 (e.g., U.S. dollars, Japanese yen), and an item description field 336 (e.g., “autographed Wayne Gretzky hockey trading card, 1980 Topps”).

Local data region 310 includes a plurality of columns 312A-312D (collectively, columns 312) and a plurality of rows 314A-314G (collectively, rows 314). Each column 312 represents a local listing for a particular marketplace, where each row 314 within that column represents a data element to be used for that local listing. Each field or cell of the local data region 310 may be referred to herein as a “local data element” or a “local data listings element,” and each column 312 of may be referred to herein as a “local listing” for purposes of discussion.

In the example embodiment, row 314A is a field for identifying a particular marketplace (e.g., marketplaces 130, 142). Row 314B is a field for identifying a particular market (e.g., a geographic region). Row 314C is a field for identifying a shipper (e.g., for delivering the target product to a purchaser of the target product). Row 314D is a field for identifying a return policy. Row 314E is a field for identifying a price for the target product. Row 314F is a field for displaying a tax amount, and row 314G is a field for displaying a total price. Rows 314F and 314G, in the example embodiment, are computed fields, based on the identified price and, in some embodiments, other information such as the identified market.

In the example embodiment, the seller populates data fields of one or more columns based on how they want to generate local listings on the various marketplaces. The seller interface module 210 enables the seller to manually enter data into some fields (e.g., by typing), such as, for example, the item description field 336 and row 314E (e.g., the price row). The seller interface module 210 enables the seller to “drag and drop” elements from the palettes 350 into associated fields or data elements of local data region 310 and/or shared data region 330. More specifically, each palette 350 is enabled to populate certain types of fields on the seller GUI 300. For example, the marketplace palette 350E includes a plurality of marketplace identifiers (e.g., a name and/or logo for marketplaces 130, 142, shown in FIG. 1), and the seller interface module 210 is configured to enable the seller (through the seller GUI 30) to drag and drop a marketplace identifier into row 314A (e.g., the marketplace row). Similarly, the market palette 350D identifies a plurality of markets that may be dropped into row 314B (e.g., the market row), the shipping palette 350C identifies a plurality of shippers that may be dropped into row 314C (e.g., the shipping row), the returns palette 350B identifies a plurality of return policy options that may be dropped into row 314D (e.g., the returns row), and the payment palette 350A identifies a plurality of payment currencies or other payment options that may be dropped into the payment currency field 334.

During operation, the seller interface module 210 presents the seller GUI 300 to a seller, and the seller populates the shared data region 330 and one or more columns of the local data region 310 based on how they want to generate local listings. For example,

For example, presume the seller is selling an autographed Wayne Gretzky hockey trading card, and desires to offer the card for sale on two marketplaces, firstmarketplace.com and secondmarketplace.com. The seller selects firstmarketplace.com from the marketplace palette 350E and drags/drops the entry into row 314A of column 312A. The seller also selects secondmarketplace.com from the marketplace palette 350E and drags/drops the entry into row 314A of column 312B. As such, column 312A represents the data fields for a local listing on firstmarketplace.com, and column 312B represents the data fields for a local listing on secondmarketplace.com.

Continuing the example, the seller enters an item description into the item description field 336 (e.g., “autographed Wayne Gretzky hockey trading card, 1980 Topps”) and item condition data into the item condition field 332 (e.g., “like new”). The seller drags the “U.S. dollars” symbol from the payment palette 350A into the payment currency field 334. The fields of shared data region 330 will be used for each of the local listings created. In other words, the item description, payment currency, and item condition will be the same for each local listing created from this central listing (e.g., for each local listing for column 312A and 312B).

The seller then populates columns 312A and 312B with data specific to that associated local listing. Some data in columns 312A and 312B may be different than the other column. For example, presume the seller elects to offer the trading card for sale in a market of “Canada” for the firstmarketplace.com listing, and “USA” for the secondmarketplace.com listing. As such, the seller drags a Canada indicator from the market palette 350D into the market row 314B of column 312A (e.g., the firstmarketplace.com listing), and also drags a USA indicator from the market palette 350D into the market row 314B of column 312B (e.g., the secondmarketplace.com listing). Further, the seller may perceive that Canadians may be willing to pay slightly more for this type of product, so the seller enters a purchase price of “$200.00” in the price row 314E of column 312A (the “Canada” market listing), and the seller enters a purchase price of “$185” in the price row 314E of column 312B (the “USA” market listing).

Some data in columns 312A and 312B may be the same as the other column. For example, presume that “Shipper #1” is available in both selected markets and through both identified marketplaces. The seller may drag the “Shipper #1” identifier into both the shipping row 314C of columns 312A and 312B. Similarly, the seller may also want a “No Returns” policy on both listings, so the seller drags the “No Returns” identifier from the returns palette 350B into the returns row 314D of both columns 312A and 312B.

Some data in columns 312A and 312B may be automatically populated (e.g., based on data entered into other fields). For example, the tax row 314F may be automatically populated with sales tax based on one or more of the price entered into the price row 314E, the selected payment currency 334, and/or the market row 314B. The total price row 314G may also be automatically populated as, e.g., the price row 314E plus the tax row 314F.

In some embodiments, the seller GUI 300 may include one or more fields duplicated in both the local data region 310 and the shared data region 330. For example, presume the shared data region 330 includes a price field (a “shared price field”, not shown) similar to the prices shown in price row 314E. These fields are referred to herein as “duplicated fields,” where a duplicated field has a first field in the shared data region 330 and one or more second fields in the local data region 310. During operation, if the seller populates the shared first field (i.e., in the shared data region 330) but does not populate one or more of the associated second fields (i.e., in the local data region 310), the shared first field may be used as a “default value” for the empty second field(s). In other words, and continuing the example, presume the seller populates the “shared” price field with $200 and does not provide a price on the price row 314E for the secondmarketplace.com listing, then the shared first field may be used as the price for the secondmarketplace.com listing. In other words, a shared data listing element may be used for a particular listing if no local data listing element is provided for a particular local listing on a particular adjunct marketplace.

Upon completion of each of the columns 312A and 312B, and the shared data region 330, the seller clicks the submit button 360 to submit the central listing for processing.

In some embodiments, one or more palettes may change or one or more fields may be value-restricted based on values within other fields of the local data region 310. For example, the seller may drag a particular market, such as “India” (e.g., a geographic region), into column 312A. Presume Shipper A does not operate in that geographic region, but Shippers B, C, and D do operate in that region. In some embodiments, the central listings engine 150 may update the palette to remove the option of Shipper A (e.g., when the column 312A is “selected”). In other embodiments, the central listings engine 150 may value-restrict the “shipper” field (e.g., row 314C) for the column 312A identifying the India market from accepting “Shipper A”. In other words, though the seller may still select and drag “Shipper A” from the shipping palette 350C, the “drop” action may be disabled for “Shipper A” going into the shipping row 314C of column 312A. In some embodiments, return policy palette 350B may be restricted based on local regulations (e.g., the value in the market row 314B) or the hosting marketplace (e.g., the value in the marketplace row 314A) and, as such, may similarly have restricted values.

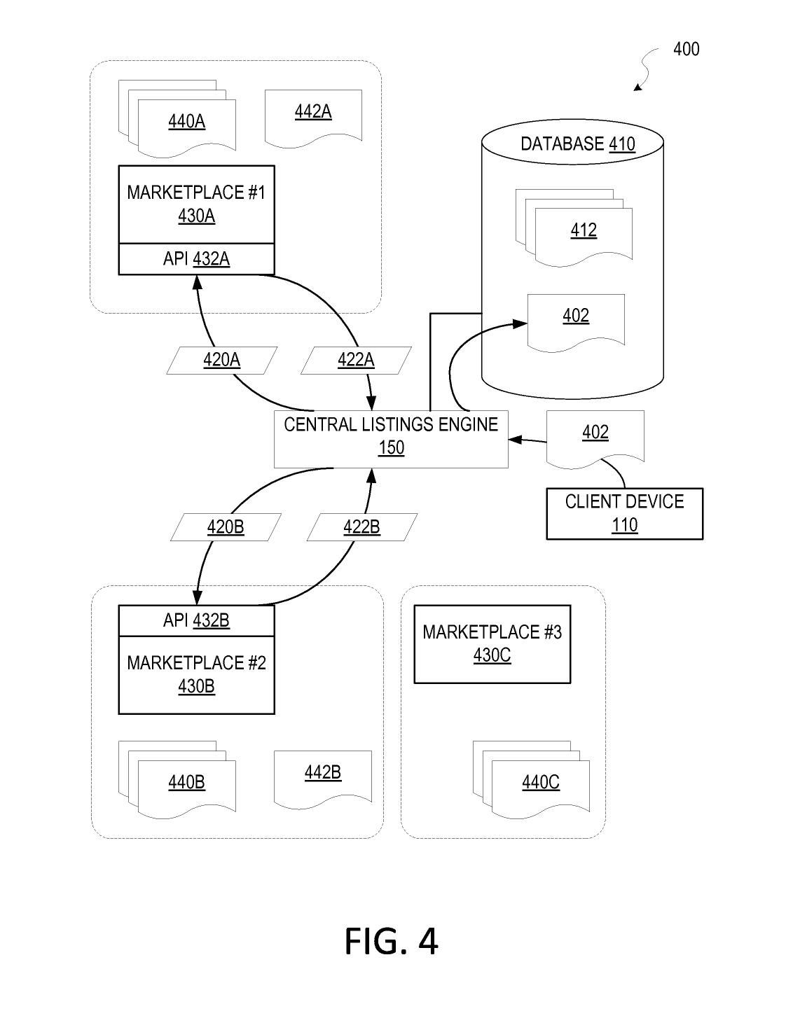

FIG. 4 is a diagram 400 illustrating communications between the central listings engine 150 and a plurality of marketplaces 430A, 430B, and 430C (collectively, marketplaces 430) during the processing of a central listing 402. In some embodiments, marketplaces 430 are similar to marketplaces 130 (shown in FIG. 1). In the example, the central listing 402 is entered by a user, such as seller 106 (shown in FIG. 1), using the seller GUI 300 (shown in FIG. 3). The central listing 402 includes offering information as described above (e.g., data described in reference to the shared data region 330 and local data region 310 of the seller GUI 300).

Continuing the above example, presume the seller enters the central listing 402 for the autographed Wayne Gretzky hockey trading card as described above. In the example embodiment, Marketplace #1 430A is firstmarketplace.com, within which the seller has indicated a “Canada” market to offer the target product, and Marketplace #2 430B is secondmarketplace.com, within which the seller has indicated a “USA” market to offer the same target product. Upon submission of the central listing 402, the central listings engine 150 stores the central listing 402 in a database 410 of central listings 412. The database 410 may be similar to databases 126 (shown in FIG. 1). The central listings engine 150 generates a unique identifier for the central listing 402 such that it may be uniquely identified amongst the other central listings 412 in the database 410.

In the example embodiment, the central listings engine 150 generates a listing creation request 420A, 420B (collectively, listing creation requests 420) for each local listing identified in the central listing 402 (e.g., for each column 312 (shown in FIG. 3) populated by the seller). For example, the central listings engine 150 generates a listing creation request 420A for marketplace #1 430A (e.g., firstmarketplace.com) that includes the fields from the shared data region 330 (the “shared data”) as well as the fields from column 312A (e.g., the column 312 of the local data region 310 associated with the first listing). This listing creation request 420A is transmitted to marketplace #1 430A. Similarly, the central listings engine 150 generates another listing creation request 420B for marketplace #2 430B (e.g., secondmarketplace.com) that includes the same fields from the shared data region 330, but instead includes the fields from column 312B (e.g., the column 312 of the local data region 310 associated with the second listing). This listing creation request 420B is transmitted to marketplace #2 430B. In this example, the seller did not provide a listing for marketplace #3 430C in central listing 402. As such, no listing creation request is generated for or transmitted to marketplace #3 430C.

In the example embodiment, each marketplace 430 includes a database of local listings 440A, 440B, and 440C (collectively, local listings 440). These local listings 440 represent, for example, pre-existing listings existing within the scope of the associated marketplace. In other words, and for example, marketplace #1 430A includes local listings 440A for other products and services offered for sale on firstmarketplace.com (e.g., by the seller 106 and many other sellers), and marketplace #2 430B includes local listings 440B for other products and services offered for sale on secondmarketplace.com. In some embodiments, each marketplace 430 may generate and maintain a unique identifier for each local listing 440 such as to enable unique identification of individual local listings 440.

In the example embodiment, upon receipt of a listing creation request (e.g., listing creation requests 420A and 420B), the receiving marketplace 430 creates local listings 442A and 442B (collectively, local listings 442) in the associated marketplace 430 and, more specifically, with the offer data provided in the request 420. In some embodiments, the listing creation request 420 may also include the unique identifier associated with the central listing 402.

For example, upon receiving listing creation request 442A, marketplace #1 430A creates local listing 442A with the shared data described above and with the local data of column 312A (e.g., marketplace=“Canada”, price=$200, etc.). As such, the local listing 442A is offered as a local listing on marketplace #1 430A in the Canada market. Similarly, upon receiving listing creation request 442B, marketplace #2 430B creates local listing 442B with the shared data described above and with the local data of column 312B (e.g., marketplace=“USA”, price=$185, etc.). As such, the local listing 442B is offered as a local listing on marketplace #2 430B in the USA market.

In some embodiments, upon creation of the local listings 442, the associated marketplaces 430 may transmit response messages 422A and 422B (collectively, response messages 422). The response messages 422 may include, for example, confirmation information (e.g., an acknowledgement that the listing creation request 420 was received and processed), the unique identifier established for the local listing 442, and other information associated with the local listing 442. In some embodiments, the central listings engine 150 may update the central listing 402 with each unique identifier for each local listing 442 associated with the central listing 402, confirmation data, or any other data received via response 442.

In some embodiments, the central listings engine 150 transmits query messages (not separately shown) to marketplaces 430 inquiring about local listings 442 and receives response messages (not separately shown) to those queries. Some examples of query messages may include a status request (e.g., to determine whether the local listing 442 is still active, or has sold, or has expired, etc.), or a data request (e.g., to determine how many views the item has had, how many local users may be “watching” the item). Such responsive “query results data” regarding the local listings 442 may be stored or updated in database 410 (e.g., as a part of central listing 402).

In some embodiments, the central listings engine 150 receives update messages (e.g., unsolicited communications) (not separately shown) from marketplaces 430 regarding local listings 442. Some examples of update messages may include an expiration or cancellation message (e.g., when the local listing 442 has expired, or has been cancelled, or otherwise “de-listed” from the local marketplace 430), or a sale message (e.g., when the local listing 442 has sold). A de-listed message may include a status indicator indicating the reason for the de-listing. A sale message may include sale details (e.g., sale price, buyer information such as name and shipping address). Such responsive “update data” regarding the local listings 442 may be stored or updated in database 410 (e.g., as a part of central listing 402). In some embodiments, the update message may provide the unique identifier for the local listing 442, or the unique identifier of the central listing 402 (e.g., in order to identify the associated central listing 402 from the other central listings 412).

In some embodiments, the central listings engine 150 may transmit an update operation or “update message” (not separately shown) associated with the central listing 402 and/or the local listings 442 to one or more of the associated marketplaces 430. In some embodiments, the update operation may include a cancellation operation associated with the central listing 402 and/or an associated local listing 442. A cancellation operation may be performed based on an occurrence such as the sale of a local listing, or on the voluntary cancellation of the central listing 150 by the seller. For example, presume that there is only a single product (e.g., a single autographed hockey trading card) associated with the central listing 402. Further, presume that the local listing 442A sold to a buyer on marketplace 430A. Upon receiving an update message from the selling marketplace 430A indicating the sale of the local listing 442A, the central listings engine 150 may transmit an update operation to any other marketplaces 430 having local listings 442 associated with that central listing 402. In this example, the central listings engine 150 transmits an update operation to marketplace #2 430B indicating that the local listing 442B should be cancelled, or de-listed, or has sold. As such, the central listings engine 150 coordinates updating local listings 442 across multiple marketplaces 430.

In some embodiments, the central listings engine 150 communicates with the marketplaces 430 via application program interfaces (APIs) 432A and 432B (collectively, APIs 432) or message query (MQ) interfaces (not shown). In other words, the various messages such as listings creation requests 420 and responses 422 may be communicated back and forth via API messages. In some embodiments, APIs 432 may be similar to API 132B (shown in FIG. 1). Further, in some embodiments, each individual marketplace 430 may have differing APIs 432. In other words, the protocol for communicating with API 432A of marketplace #1 430A may be different than the protocol for communicating with API 432B of marketplace #2 430B. As such, when central listings engine 150 communicates messages such as listings creation requests 420 and receives responses 422, the central listings engine 150 is configured to communicate with each marketplace 430 based on their specific API 432.

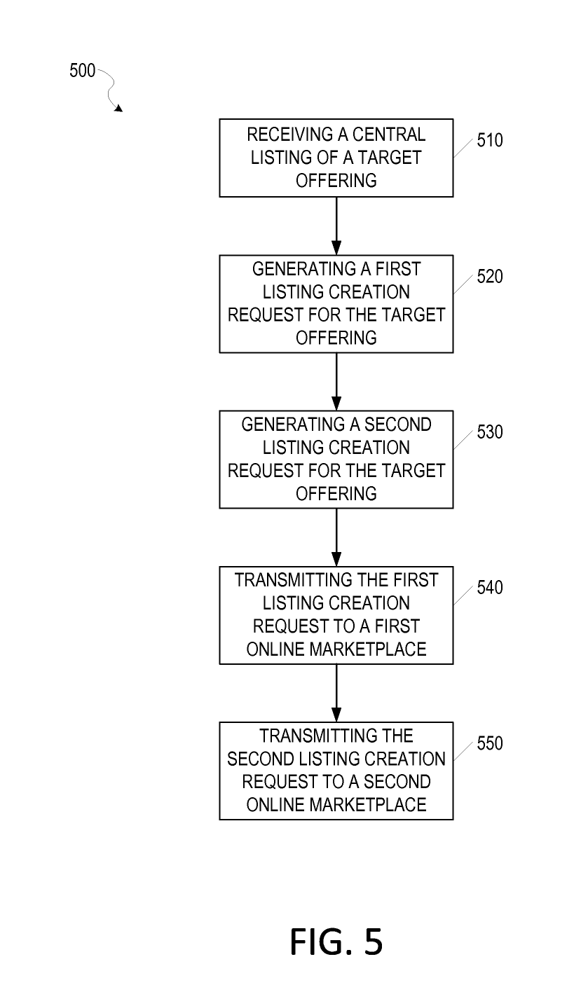

FIG. 5 is a diagram of an example method 500 for creation and management of listings across multiple marketplaces, such as marketplaces 130, 142 (shown in FIG. 1) and marketplaces 430 (shown in FIG. 4). In the example embodiment, method 500 is performed by a computing device including a processor and memory which may be similar to the central listings engine 150 (shown in FIGS. 1 and 4). Method 500 includes receiving 510 a central listing associated with a target offering, the central listing including a plurality of data elements, the target offering including one of a product and a service (e.g., a seller presenting for sale online), the plurality of data elements including (i) a first subset of data elements including identification of a first online marketplace and (ii) a second subset of data elements including identification of a second online marketplace. In some embodiments, receiving 510 a central listing associated with a target offering further includes receiving the central listing from a third online marketplace, wherein the third online marketplace presents the target offering as a third local listing on the third online marketplace, wherein one or more of the plurality of data elements are identified from the third local listing.

In the example embodiment, method 500 also includes generating 520 a first listing creation request associated with the target offering, the first listing creation request including the first subset of data elements. The method 500 also includes generating 530 a second listing creation request associated with the target offering, the second listing creation request including the second subset of data elements. The method 500 further includes transmitting 540 the first listing creation request to the first marketplace, thereby creating a first local listing for the target offering on the first online marketplace. The method 500 also includes transmitting 550 the second listing creation request to the second marketplace, thereby creating a second local listing for the target offering on the second online marketplace.

In some embodiments, the method 500 also includes providing a seller interface to the seller, the seller interface including a first local data elements region and a second local data elements region, wherein the seller provides the first subset of data elements within the first local data elements region and the second subset of data elements into the second local data elements region. In some embodiments, the seller interface further includes a shared data elements region, the plurality of data elements further includes a third subset of data elements, the seller provides the third subset of data elements in the shared data elements region, the first listing creation request further includes the third subset of data elements, and the second listing creation request further includes the third subset of data elements.

In some embodiments, the method 500 further includes receiving a status message associated with the first local listing from the first online marketplace indicating a sale of the target offering, and transmitting an update message associated with the second local listing to the second online marketplace based at least in part on the status message.

In some embodiments, the first local listing has a first local listings identifier within the first marketplace, the second local listing has a second local listings identifier within the second marketplace, and the method 500 further includes receiving a first response message associated with the first listing creation request from the first marketplace, the first response message including the first local listings identifier, receiving a second response message associated with the second listing creation request from the second marketplace, the second response message including the second local listings identifier, and storing the first local listings identifier and the second local listings identifier in the memory as associated with the target offering.

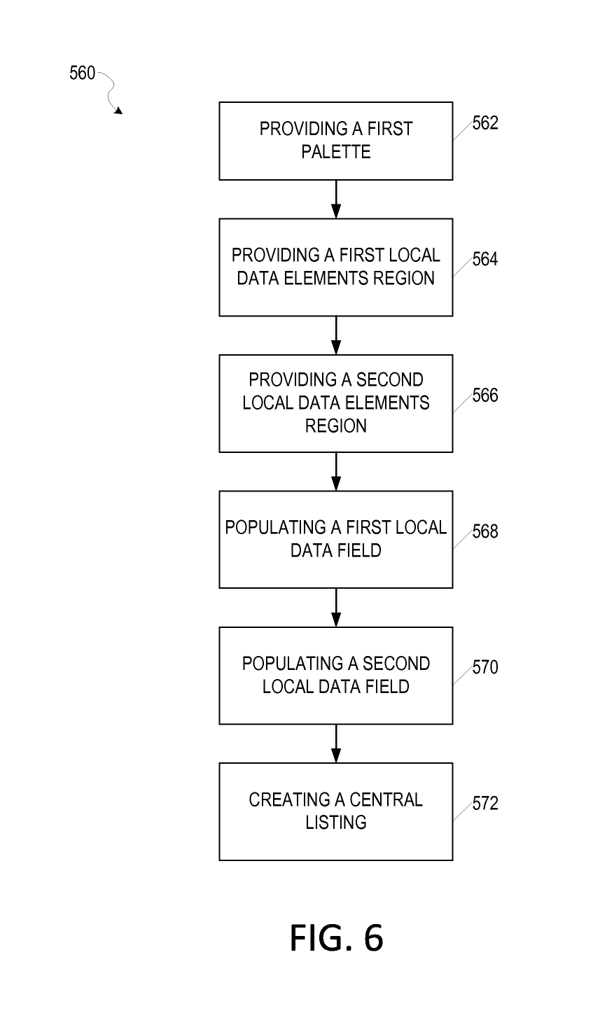

FIG. 6 is a flow chart of an example method 560 for providing a seller interface for creating a central listing on a central listings engine. The method is performed by at least one processor and a memory. The method includes providing 562, by the processor, a first palette including a plurality of field values associated with a first palette data type. The method also includes providing 564 a first local data elements region on a display device, the first local data elements region including a first local data field configured to receive a field value of the plurality of field values, and providing 566 a second local data elements region on the display device, the second local data elements region including a second local data field configured to receive a field value of the plurality of field values.

The method 560 further includes populating 568 the first local data field based on the seller identifying a first field value from the first palette and populating 570 the second local data field based on the seller identifying a second field value from the first palette. The method 560 also includes creating 572 a central listing on the central listings engine, the central listing including the first field value and the second field value. In some embodiments, creating a central listing further includes creating the central listing including first local listing data associated with a first local listing and second local listing data associated with a second local listing, the first local listing data including the first local data field, the second local listing data including the second local data field.

In some embodiments, each field value of the plurality of field values of the first palette identifies an online marketplace. In some embodiments, each field value of the plurality of field values of the first palette identifies one of a geographic market identifier, a shipping identifier, and a return policy. In some embodiments, the method 560 also includes providing a shared data elements region on the display device, the shared data elements region including a first shared data element, and receiving input of the first shared data element from the seller, wherein the central listing further includes the first shared data element. In some embodiments, the method 560 includes providing a third local data field configured to accept a third field value from the seller, providing a fourth local data field configured to not accept input from the seller, calculating a fourth field value based at least in part on the third field value, and populating the fourth local data field with the calculated fourth field value, wherein the central listing further includes the third field value and the fourth field value. In some embodiments, the method 560 includes transmitting the first local listing data to a first online marketplace and transmitting the second local listing data to a second online marketplace.

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

The modules, methods, applications and so forth described in conjunction with FIGS. 1-5 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

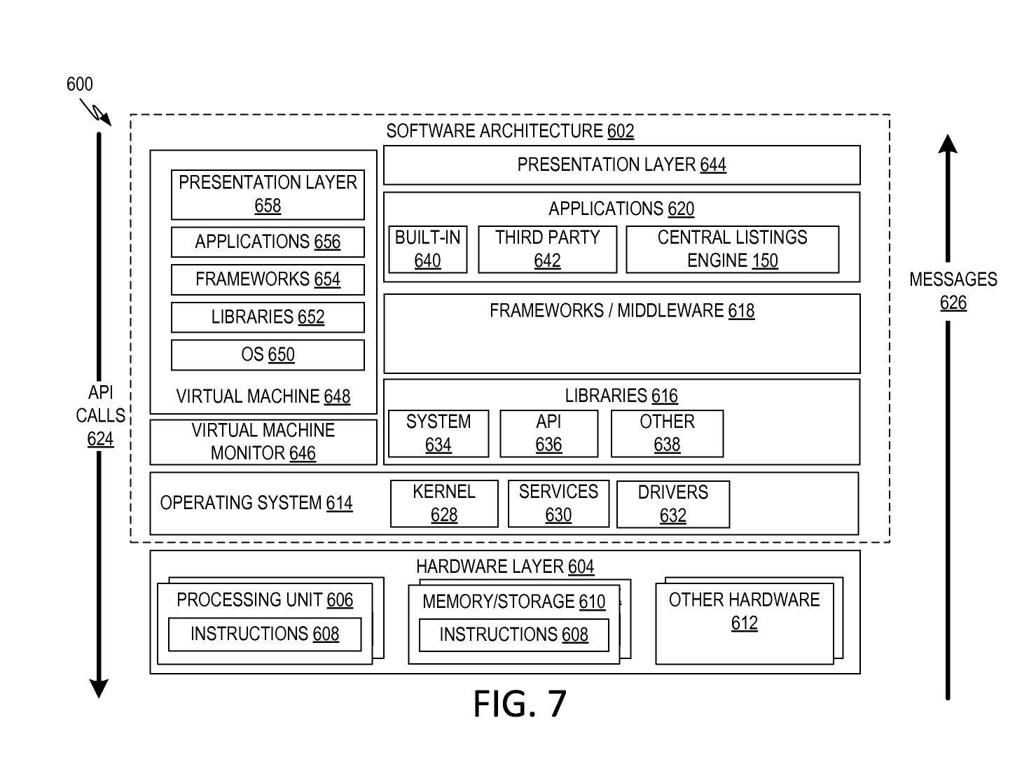

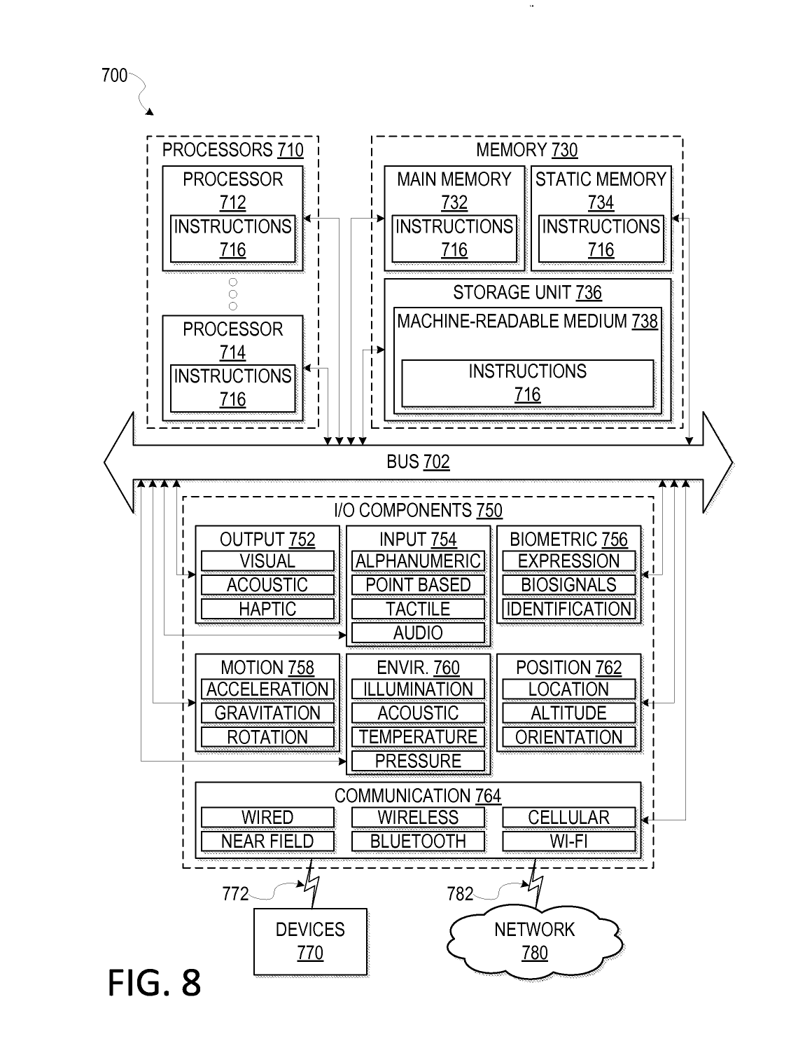

FIG. 7 is a block diagram 600 illustrating a representative software architecture 602, which may be used in conjunction with various hardware architectures herein described. FIG. 7 is merely a non-limiting example of a software architecture and it will be appreciated that many other architectures may be implemented to facilitate the functionality described herein. The software architecture 602 may be executing on hardware such as machine 700 of FIG. 8 that includes, among other things, processors 710, memory 730, and I/O components 750. A representative hardware layer 604 is illustrated and can represent, for example, the machine 700 of FIG. 8. The representative hardware layer 604 comprises one or more processing units 606 having associated executable instructions 608. Executable instructions 608 represent the executable instructions of the software architecture 602, including implementation of the methods, modules and so forth of FIGS. 1-5. Hardware layer 604 also includes memory and/or storage modules 610, which also have executable instructions 608. Hardware layer 604 may also comprise other hardware as indicated by 612 which represents any other hardware of the hardware layer 604, such as the other hardware illustrated as part of machine 700.

In the example architecture of FIG. 7, the software 602 may be conceptualized as a stack of layers where each layer provides particular functionality. For example, the software 602 may include layers such as an operating system 614, libraries 616, frameworks/middleware 618, applications 620 and presentation layer 622. Operationally, the applications 620 and/or other components within the layers may invoke application programming interface (API) calls 624 through the software stack and receive a response, returned values, and so forth illustrated as messages 626 in response to the API calls 624. The layers illustrated are representative in nature and not all software architectures have all layers. For example, some mobile or special purpose operating systems may not provide a frameworks/middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system 634 libraries (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks 618 (also sometimes referred to as middleware) may provide a higher-level common infrastructure that may be utilized by the applications 620 and/or other software components/modules. For example, the frameworks 618 may provide various graphic user interface (GUI) functions, high-level resource management, high-level location services, and so forth. The frameworks 618 may provide a broad spectrum of other APIs that may be utilized by the applications 620 and/or other software components/modules, some of which may be specific to a particular operating system or platform.

The applications 620 includes built-in applications 640 and/or third party applications 642. Examples of representative built-in applications 640 may include, but are not limited to, a contacts application, a browser application, a book reader application, a location application, a media application, a messaging application, and/or a game application. Third party applications 642 may include any of the built in applications as well as a broad assortment of other applications. In a specific example, the third party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 642 may invoke the API calls 624 provided by the mobile operating system such as operating system 614 to facilitate functionality described herein.

The applications 620 may utilize built in operating system functions (e.g., kernel 628, services 630 and/or drivers 632), libraries (e.g., system 634, APIs 636, and other libraries 638), frameworks/middleware 618 to create user interfaces to interact with users of the system. Alternatively, or additionally, in some systems interactions with a user may occur through a presentation layer, such as presentation layer 644. In these systems, the application/module “logic” can be separated from the aspects of the application/module that interact with a user.

Some software architectures utilize virtual machines. In the example of FIG. 7, this is illustrated by virtual machine 648. A virtual machine creates a software environment where applications/modules can execute as if they were executing on a hardware machine (such as the machine of FIG. 8, for example). A virtual machine is hosted by a host operating system (operating system 614 in FIG. 8) and typically, although not always, has a virtual machine monitor 646, which manages the operation of the virtual machine as well as the interface with the host operating system (i.e., operating system 614). A software architecture executes within the virtual machine such as an operating system 650, libraries 652, frameworks/middleware 654, applications 656 and/or presentation layer 658. These layers of software architecture executing within the virtual machine 648 can be the same as corresponding layers previously described or may be different.

In the example embodiment, the central listings engine 150 operates as an application in the applications 620 layer. However, in some embodiments, the central listings engine 150 may operate in other software layers, or in multiple software layers (e.g., framework 618 and application 620), or in any architecture that enables the systems and methods as described herein.

FIG. 8 is a block diagram illustrating components of a machine 700, according to some example embodiments, able to read instructions from a machine-readable medium (e.g., a machine-readable storage medium) and perform any one or more of the methodologies discussed herein. Specifically, FIG. 8 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions may cause the machine to execute the flow diagrams of FIGS. 4 and 5. Additionally, or alternatively, the instructions may implement the seller interface module 210, listings management module 220, and marketplace communications module 230, and so forth. The instructions transform the general, non-programmed machine into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 712 and processor 714 that may execute instructions 716. The term “processor” is intended to include multi-core processor that may comprise two or more independent processors (sometimes referred to as “cores”) that may execute instructions contemporaneously. Although FIG. 8 shows multiple processors, the machine 700 may include a single processor with a single core, a single processor with multiple cores (e.g., a multi-core process), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of processors 710 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes transitory signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 8. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772 respectively. For example, the communication components 764 may include a network interface component or other suitable device to interface with the network 780. In further examples, communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as, location via Internet Protocol (IP) geo-location, location via Wi-Fi® signal triangulation, location via detecting a NFC beacon signal that may indicate a particular location, and so forth.

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to devices 770. The term “transmission medium” shall be taken to include any intangible medium that is capable of storing, encoding, or carrying instructions 716 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A central listings engine for creating listings on one or more online marketplaces, the central listings engine comprising at least one processor and a memory, the at least one processor is programmed to:
receive a central listing associated with a target offering, the central listing including a plurality of data elements, the target offering including one of a product and a service, the plurality of data elements including (i) a first subset of data elements including identification of a first online marketplace and (ii) a second subset of data elements including identification of a second online marketplace;
generate a first listing creation request associated with the target offering, the first listing creation request including the first subset of data elements;
generate a second listing creation request associated with the target offering, the second listing creation request including the second subset of data elements;
transmit the first listing creation request to the first marketplace to create a first local listing for the target offering on the first online marketplace; and
transmit the second listing creation request to the second marketplace to create a second local listing for the target offering on the second online marketplace.

2. The central listings engine of claim 1, wherein the at least one processor is further programmed to:
provide a seller interface to a seller of the target offering, the seller interface including a first local data elements region and a second local data elements region,
wherein the seller provides the first subset of data elements within the first local data elements region and the second subset of data elements into the second local data elements region.

3. The central listings engine of claim 2, wherein the seller interface further includes a shared data elements region, wherein the plurality of data elements further includes a third subset of data elements, wherein the seller provides the third subset of data elements in the shared data elements region, wherein the first listing creation request further includes the third subset of data elements, wherein the second listing creation request further includes the third subset of data elements.

4. The central listings engine of claim 1, wherein the at least one processor is further programmed to:
receive a status message associated with the first local listing from the first online marketplace indicating a sale of the target offering; and
transmit an update message associated with the second local listing to the second online marketplace based at least in part on the status message.

5. The central listings engine of claim 1, wherein the first local listing has a first local listings identifier within the first marketplace, wherein the second local listing has a second local listings identifier within the second marketplace, wherein the at least one processor is further programmed to:
receive a first response message associated with the first listing creation request from the first marketplace, the first response message including the first local listings identifier;
receive a second response message associated with the second listing creation request from the second marketplace, the second response message including the second local listings identifier; and
store the first local listings identifier and the second local listings identifier in the memory as associated with the target offering.

6. The central listings engine of claim 1, wherein the central listing is received from a third online marketplace, wherein the third online marketplace presents the target offering as a third local listing on the third online marketplace, wherein one or more of the plurality of data elements are identified from the third local listing.

7. The central listings engine of claim 1, wherein the processor is further programmed to:
generate a central listing identifier associated with the central listing; and
store a central listing record in the memory, the central listing record associated with the central listing and including the central listing identifier, the first subset of data elements, and the second subset of data elements in the memory.

8. A computer-implemented method for creating listings on one or more online marketplaces, the method performed by at least one processor and a memory, the method comprising:
receiving a central listing associated with a target offering, the central listing including a plurality of data elements, the target offering including one of a product and a service, the plurality of data elements including (i) a first subset of data elements including identification of a first online marketplace and (ii) a second subset of data elements including identification of a second online marketplace;
generating a first listing creation request associated with the target offering, the first listing creation request including the first subset of data elements;
generating a second listing creation request associated with the target offering, the second listing creation request including the second subset of data elements;
transmitting the first listing creation request to the first marketplace to create a first local listing for the target offering on the first online marketplace; and
transmitting the second listing creation request to the second marketplace to create a second local listing for the target offering on the second online marketplace.

9. The method of claim 8 further comprising:
providing a seller interface to a seller of the target offering, the seller interface including a first local data elements region and a second local data elements region,
wherein the seller provides the first subset of data elements within the first local data elements region and the second subset of data elements into the second local data elements region.

10. The method of claim 9, wherein the seller interface further includes a shared data elements region, wherein the plurality of data elements further includes a third subset of data elements, wherein the seller provides the third subset of data elements in the shared data elements region, wherein the first listing creation request further includes the third subset of data elements, wherein the second listing creation request further includes the third subset of data elements.

11. The method of claim 8 further comprising:
receiving a status message associated with the first local listing from the first online marketplace indicating a sale of the target offering; and
transmitting an update message associated with the second local listing to the second online marketplace based at least in part on the status message.

12. The method of claim 8, wherein the first local listing has a first local listings identifier within the first marketplace, wherein the second local listing has a second local listings identifier within the second marketplace, the method further comprising:
receiving a first response message associated with the first listing creation request from the first marketplace, the first response message including the first local listings identifier;
receiving a second response message associated with the second listing creation request from the second marketplace, the second response message including the second local listings identifier; and
storing the first local listings identifier and the second local listings identifier in the memory as associated with the target offering.

13. The method of claim 8, wherein receiving a central listing associated with a target offering further includes receiving the central listing from a third online marketplace, wherein the third online marketplace presents the target offering as a third local listing on the third online marketplace, wherein one or more of the plurality of data elements are identified from the third local listing.

14. The method of claim 8 further comprising:
generating a central listing identifier associated with the central listing; and
storing a central listing record in the memory, the central listing record associated with the central listing and including the central listing identifier, the first subset of data elements, and the second subset of data elements in the memory.

15. A non-transitory machine-readable storage device storing a set of instructions that, when executed by at least one processor, causes the at least one processor to perform a set of operations comprising:
receiving a central listing associated with a target offering, the central listing including a plurality of data elements, the target offering including one of a product and a service, the plurality of data elements including (i) a first subset of data elements including identification of a first online marketplace and (ii) a second subset of data elements including identification of a second online marketplace;
generating a first listing creation request associated with the target offering, the first listing creation request including the first subset of data elements;
generating a second listing creation request associated with the target offering, the second listing creation request including the second subset of data elements;
transmitting the first listing creation request to the first marketplace to create a first local listing for the target offering on the first online marketplace; and
transmitting the second listing creation request to the second marketplace to create a second local listing for the target offering on the second online marketplace.

16. The storage device of claim 15, wherein the set of instructions further causes the at least one processor to:
provide a seller interface to a seller of the target offering, the seller interface including a first local data elements region and a second local data elements region,
wherein the seller provides the first subset of data elements within the first local data elements region and the second subset of data elements into the second local data elements region.

17. The storage device of claim 16, wherein the seller interface further includes a shared data elements region, wherein the plurality of data elements further includes a third subset of data elements, wherein the seller provides the third subset of data elements in the shared data elements region, wherein the first listing creation request further includes the third subset of data elements, wherein the second listing creation request further includes the third subset of data elements.

18. The storage device of claim 15, wherein the set of instructions further causes the at least one processor to:
receive a status message associated with the first local listing from the first online marketplace indicating a sale of the target offering; and
transmit an update message associated with the second local listing to the second online marketplace based at least in part on the status message.

19. The storage device of claim 15, wherein the first local listing has a first local listings identifier within the first marketplace, wherein the second local listing has a second local listings identifier within the second marketplace, wherein the set of instructions further causes the at least one processor to:
receive a first response message associated with the first listing creation request from the first marketplace, the first response message including the first local listings identifier;
receive a second response message associated with the second listing creation request from the second marketplace, the second response message including the second local listings identifier; and
store the first local listings identifier and the second local listings identifier in the memory as associated with the target offering.

20. The storage device of claim 15, wherein the central listing is received from a third online marketplace, wherein the third online marketplace presents the target offering as a third local listing on the third online marketplace, wherein one or more of the plurality of data elements are identified from the third local listing.
